(19) United States
(12) Patent Application Publication
(10) Pub. No.: US 2009/0169712 A1
(43) Pub. Date: Jul. 2, 2009

(54) Method for sterilization of native soybean protein composition

(75) Inventors: Jiro Kanamori, Tsukubamirai-shi (JP); Masahiko Samoto, Tsukubamirai-shi (JP); Chiaki Miyazaki, Tsukubamirai-shi (JP); Masaaki Miyamoto, Tsukubamirai-shi (JP)

Correspondence Address: WENDEROTH, LIND & PONACK, L.L.P., 1030 15th Street, N.W.,, Suite 400 East, Washington, DC, 20005-1503, US

(73) Assignee: FUJI OIL COMPANY, LIMITED

(21) Appl. No.: 12/379,753

(22) Filed: Feb. 27, 2009

Related U.S. Application Data
(63) Continuation-in-part of application No. PCT/JP2007/066580, filed on Aug. 27, 2007.

(30) Foreign Application Priority Data
Aug. 29, 2006 (JP) 2006-231759

(51) Int. Cl. A23L 1/16; A23L 3/16; A23J 1/14

(52) U.S. Cl. 426/656; 426/521; 426/451; 426/459

(57) ABSTRACT

Disclosed is a slightly denatured, sterilized soybean protein composition. The composition can be produced by sterilizing an aqueous solution of a slightly denatured soybean protein composition which has been salted to such a degree that the ionic strength becomes 0.04 or more, by heating the aqueous solution at a temperature not lower than 60° C. and lower than the denaturation temperature of a soybean protein for 30 minutes or longer.

### TECHNICAL FIELD

The present invention relates to a method for sterilization (pasteurization) of a native soybean protein composition.

### BACKGROUND ART

A protein derived from soybean is favorable in amino acid balance, and in recent years, physiological effects such as action of lowering serum cholesterol have been reported. In order to reduce risks of cholesterol and cardiologic diseases, the U.S. Food and Drug Administration (FDA) recommends intake of 25 g (6.25 g per meal) or more of high quality soybean protein in the diet per day per person. Also in Japan, as food for specified health use, food having a function of reducing serum cholesterol on the premise of intake of soybean globulin in 6 g or more per day per person has been approved.

In general, many bacterial groups derived from soil are parasitic on soybeans, and it is preferable to carry out any of sterilization treatment for providing soybeans as food material. For example, for sterilization of coli group, a heat treatment at degree of 60 to 65° C. for about 30 minutes is effective, but a soybean protein starts heat denaturation from at around 60° C., and thus, it has been difficult to stably carry out sufficient heat sterilization in temperature range where a soybean protein is not denatured.

Many soybean protein products such as isolated soybean protein, concentrated soybean protein, and soybean milk powder are subjected to a high-temperature pressurization treatment for sterilization, and the protein is denatured. Various wheat products added with a soybean protein product receive an adverse effect on their physical properties due to such denaturation, and in particular, when added to a noodle, significant adverse effects such as deterioration in noodle preparation property etc. are given. Therefore, a practical soybean protein fortified noodle has not been obtained.
Non-patent Document 1: S. Utshumi, T. Nakamura, K. Harada and T. Mori, Agric. Biol. Chem., 51(8), 2139-2144 (1987)
Non-patent Document 2: Thahn, V. H. and Shibasaki, K., J. Agric. Food Chem., 24, 117, 1976

### DISCLOSURE OF THE INVENTION

### Problem to be Solved by the Invention

An object of the present invention is to provide a slightly denatured and sterilized soybean protein composition.

### Means for Solving the Problem

The present inventors have intensive studies to solve the above-mentioned problem. It is necessary to increase a heating temperature for sterilization, however, raising a temperature causes a contradictory phenomenon such that a protein is heat-denatured. Thus, in further intensive studies, the inventors have found to apply a report from S. Utsumi, et al. (Non-patent Document 1), when an ionic strength of a soybean protein is increased by adding salts, the denaturation temperature is increased. Specifically, the present inventors have completed the present invention that addition of salts allows the ionic strength to increase, thereby raising the denaturation temperature of a soybean protein, and thus, heat sterilization can be stably carried out. There has not been an idea of applying a change in a denaturation temperature of a soybean protein due to salts to a heat sterilization technique as described above.

That is, the present invention is:
(1) A method for sterilization of native soybean protein composition comprising salting and heating an aqueous solution of soybean protein composition;
(2) The method for sterilization of native soybean protein composition according to (1), wherein ionic strength at the time of salting is 0.04 or more;
(3) The method for sterilization of native soybean protein composition according to (2), wherein conditions of heat sterilization are such that the composition temperature is 60° C. or higher, but lower than denaturation temperature of the soybean protein;
(4) The method for sterilization of native soybean protein composition according to (3), wherein the soybean protein composition contains 10% or more of β-conglycinin, and the heat sterilization conditions are lower than 65° C.;
(5) The method for sterilization of native soybean protein composition according to (3), wherein the soybean protein composition contains less than 10% of β-conglycinin, and the heat sterilization condition is lower than 85° C.;
(6) A method for producing soybean protein composition comprising using the method for sterilization according to any one of (1) to (5);
(7) A method for producing sterilized soybean protein composition according to (6), wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
cutting the noodle strip into width of 1.2 mm by cutting blade to prepare noodle string;
leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.
(8) A soybean protein composition, which is obtained by the production method according to (6) or (7).

### Effects of the Invention

According to the present invention, a sterilized and slightly denatured soybean protein composition can be obtained, and can be added to noodles and other foods in safety.

### BEST MODE FOR CARRYING OUT THE INVENTION

Hereinafter, the present invention will be explained in detail. The present invention relates to a method for sterilization of a native soybean protein composition by heating with keeping slightly denatured state, that is, a suitable state for adding to noodles, or the like.

The native soybean protein composition referred herein means a composition containing a soybean protein as the main component, that is, a concentrated soybean protein made from a soybean raw material such as soybean and defatted soybean by washed with an alcohol or an acidic liquid, soybean milk solution obtained from the soybean raw material by extracting in water or warm water and removing fiber, or an isolated soybean protein obtained by isolating a protein from the soybean milk solution by isoelectric precipitation at pH of about 4 to 5, and then re-dissolving the protein, or alternatively indicates a soybean protein composition which is dried product obtained by spray dry, freeze dry or the like of these soybean protein solutions with avoiding a treatment of denaturing a protein as much as possible. In addition, by raising G of the centrifugation when fiber is removed, a soybean protein composition with a low polar lipid amount extracted with chloroform methanol is obtained, and this soybean protein composition has favorable flavor and physical properties and is suitable in various applications as a native soybean protein composition.

Further, β-conglycinin fraction and glycinin fraction obtained by fractionation treatment as reported from Thahn, V. H., et al. (Non-patent Document 2) also can be used. In particular, a high glycinin native soybean protein composition, which is containing less than 10%, preferably only less than 7% of β-conglycinin in its protein, is preferable as a raw material for preparing a native soybean protein composition because it has higher denaturation temperature than that of a general soybean protein composition containing 10% or more of β-conglycinin in its protein. Content of β-conglycinin in a protein used herein is defined to be a value found by dyeing a gel electrophoresed by SDS-PAGE with Coomassie Brilliant Blue and decolorizing, and then measuring with a densitometer.

A native soybean protein is prepared by using various treatments for the purposes of extraction, concentration, sterilization, drying, improvement in physical properties, and the like under conditions such as temperature, pH, pressure, etc., within the ranges not causing denaturation of a protein.

A degree of denaturation of a protein due to heat sterilization can be measured from its physical properties, that is, extension of dough and hardness of noodle by noodle preparation test shown below. Specifically, 33.5 g of flour, 17.5 g of powdered soybean protein composition, 2.5 g of sodium chloride and water are mixed by hand to form into crumbly dough. An amount of water is adjusted so that the dough has appropriate hardness (hardness such as cold rice held by hand). After putting the dough to rest for 5 minutes, the dough is kneaded to put together and degassed with a vacuum sealer. The dough is combined and rolled out by a hand crank pasta machine to be noodle strip with thickness of 1.2 mm. Further, the noodle strip is cut into width of 1.2 mm by cutting blade to prepare noodle string. A measurement of physical properties of the dough is carried out by a penetration and break test. The noodle strip extended to have thickness of 1.2 mm is left to stand overnight at 4° C., and after getting back to normal temperature, the dough passes through a 1.2 mm-roller again and is cut into 40 mm×40 mm. The dough is placed on a plate having a hole with diameter of 16 mm, and the same plate with a hole (weight of 1002 g) is further placed thereon to fix the dough. Using a spherical plunger with diameter of 5 mm, the dough is penetrated at a rate of 1 mm/sec, and displacement of a break point (assuming a point of being in contact with the sample to be 0 point) is obtained as a measured value (extension of dough). When soybean protein compositions have the same constitution, as a denaturation degree is smaller, a higher value can be obtained.

Regarding physical properties of a noodle after boiling, a noodle string is left to stand overnight at 4° C., it is boiled at 100° C. for 5 minutes, and then, 15 minutes after boiling up, it is compressed to 0.1 mm from the bottom face at plunger rate of 0.05 mm/sec using a wedge-shaped plunger, thereby, a load at a break point is obtained as a measured value (hardness of noodle). When soybean protein compositions have the same constitution, as a denaturation degree is smaller, a higher value can be obtained. The denaturation degree of the soybean protein composition is preferable when both values of the extension of dough and the hardness of noodle measured by this method are 80% or more of values before the heat treatment, which indicates slight denaturation, and when the denaturation degree is within this range, difference of the denaturation degree before and after the heat treatment does not cause a practical problem.

In the case of carrying out sterilization by heating in order to obtain a sterilized soybean protein composition from an unsterilized, native soybean protein composition, it is necessary to forming the soybean protein composition into an aqueous solution and then heating it at 60° C. for 30 minutes or longer. However, in the case of a general isolated soybean protein composition containing 10% or more of β-conglycinin in its protein, in state of not salting, heating at higher than 63° C. for 30 minutes or longer causes denaturation, and a problem occurs on utilization of the isolated soybean protein as a soybean protein composition since physical properties of the soybean protein are extremely changed.

In this case, when a native soybean protein composition is subjected to a heat treatment, a denaturation temperature of the soybean protein can be increased by adding a salt to such a degree that an ionic strength is 0.04 or more, preferably 0.08 or more, and further more preferably 0.12 or more. Along with increasing of the ionic strength, the denaturation temperature is also raised, and when the ionic strength is 0.2, increase of the denaturation temperature of about 5° C. is recognized. The upper limit of the ionic strength is not particularly provided, however, when the ionic strength is too high, ash content of a soybean protein composition is increased, and strange taste is caused. In reality, the ionic strength is preferably 0.5 or less, and more preferably 0.3 or less.

Examples of a salt that is added during heating include sulfate salt, nitrate salt, carbonate salt, hydrogen carbonate salt, and chloride of which cation is selected from alkali metal such as sodium and potassium, and ammonium, etc., and for example, sodium chloride, potassium chloride, sodium sulfate, ammonium sulfate, and the like can be used, and sodium chloride is the most preferable from the viewpoints of taste and cost.

Due to this salting, a heat sterilization treatment can be carried out with keeping low denaturation state at temperature of 60° C. or higher but lower than 67° C., preferably temperature of 61° C. or higher but lower than 65° C., and further more preferably temperature of 61° C. or higher but lower than 63° C. Heating at lower than 60° C. causes a weak effect of sterilization, and heating at 68° C. or higher allows to initiate denaturation. Further, heating time for 30 minutes or longer is necessary. The upper limit of the heating time is not particularly provided, however, heating generally within 3 hours, and further, within 1 hour are appropriate since heating for a long time deteriorates production efficiency. A concentration of an aqueous soybean protein composition during heating is suitably 2 to 20% by weight, and preferably 5 to 15% by weight as solid content in the solution.

When a native soybean protein composition is a high glycinin native soybean protein composition, denaturation temperature is originally high as compared with a general soybean protein composition, and addition of a salt makes it possible to heat at around 80° C. Thus, an efficient heat sterilization treatment can be carried out with keeping a slightly denatured state at 60° C. or higher but lower than 85° C., preferably at temperature of high sterilization effect of 70° C. or higher but lower than 85° C., and more preferably 80° C. or higher but lower than 85° C. In this heat sterilization treatment, heating at lower than 60° C., an effect of sterilization is weak and heating at 85° C. or higher allows to initiate denaturation.

Sterilization is required to carry out in pH range where a protein is hardly heat-denatured. It is suitable that pH is 5 to 8.5, and preferably 6.56 to 7.5, but it is possible to use pH range other than these ranges depending on heating temperature.

### EXAMPLES

Examples will be described in the following, however the technical scope of the present invention is not limited to them.

### Difference of Heat Denaturation Degree at Each Temperature Due to Presence or Absence of Sodium Chloride

To a defatted soybean, 7-fold amount of water was added, the mixture was adjusted to pH 7 with sodium hydroxide to be mixed and extracted, and after removing a precipitate by centrifugation, water of 5-fold amount of the defatted soybean was further added to the residue and treated in the same manner to obtain extracted solution. It was adjusted to pH 4.5 with hydrochloric acid to precipitate a protein and recovered by centrifugation. Water was added and then the solution was neutralized with sodium hydroxide, and it was spray-dried at a hot air temperature of 180° C. and an exhaust air temperature of 70° C. to obtain a powdery isolated soybean protein A.

The isolated soybean protein A was dissolved so as to have a concentration of 12% by weight, and heated in a constant temperature water bath at each temperature for 30 minutes. When sodium chloride was added, it was added at a concentration of 1.2% by weight (ionic strength of 0.21) in the solution, and the solution was heated in the same manner. It was freeze-dried, and then pulverized, and a denaturation degree was evaluated by noodle preparation test. When sodium chloride was added, compositions thereof were adjusted so that masses of sodium chloride and protein were constant when noodle was prepared. The denaturation degree was expressed by a relative value, assuming an extension of dough without heating and a hardness of noodle without heating respectively as 100%.

In Comparative Examples 2 to 4 of which sodium chloride was not added, when heating temperature was at 60° C. or lower, both of an extension of dough and a hardness of noodle were 80% or more and a denaturation degree was slight, however, when at 63° C. or higher, the hardness of noodle was lower than 80% and denaturation was recognized. In Examples 1 and 2 of which sodium chloride was added, when heating temperature was at 65° C. or lower, both of the extension of dough and the hardness of noodle were 80% or more, and denaturation was slight. However, even when sodium chloride was added, in Comparative Example 5 which was heated at 68° C., the hardness of noodle was lower than 80%, and denaturation was recognized.

TABLE 1
Difference of heat denaturation degree at each
temperature due to presence or absence of sodium chloride

| | | Concentration of | | | |
|---|---|---|---|---|---|
| | Heating | sodium chloride | | Denaturation degree | |
| | temperature | | (Ionic | Extension | Hardness |
| | (° C.) | (wt %) | strength) | of dough | of noodle |
| Comparative | Without | 0 | 0 | 100% | 100% |
| Example 1 | heating | | | | |
| Comparative | 60 | ↑ | ↑ | 96.7% | 95.2% |
| Example 2 | | | | | |
| Comparative | 63 | ↑ | ↑ | 98.4% | 78.8% |
| Example 3 | | | | | |
| Comparative | 65 | ↑ | ↑ | 88.2% | 69.7% |
| Example 4 | | | | | |
| Example 1 | 60 | 1.2 | 0.21 | 103% | 88.0% |
| Example 2 | 65 | ↑ | ↑ | 101% | 81.7% |
| Comparative | 68 | ↑ | ↑ | 85.0% | 66.1% |
| Example 5 | | | | | |

### Difference of Heat Denaturation Degree Due to Concentration of Sodium Chloride

The isolated soybean protein A was dissolved so as to have a concentration of 12% by weight, sodium chloride was added and dissolved therein at each concentration of 0.3 to 0.9% by weight (ionic strength of 0.05 to 0.15) and then heated in a constant temperature water bath at 65° C. for 30 minutes. The reaction solution was freeze-dried and then pulverized, and a denaturation degree was evaluated by noodle preparation test. Compositions thereof were adjusted so that the amount of sodium chloride and protein were constant when noodle was prepared. The denaturation degree was expressed by a relative value, assuming an extension of dough without heating and a hardness of noodle without heating respectively as 100%.

In Examples 3 to 5 of which sodium chloride was added in an amount of 0.3% by weight (ionic strength of 0.05) or more, both of the extension of dough and the hardness of noodle were 80% or more, and denaturation was slight.

TABLE 2
Difference of heat denaturation degree due to
concentration of sodium chloride

| | | Concentration of | | | |
|---|---|---|---|---|---|
| | Heating | sodium chloride | | Denaturation degree | |
| | temperature | | (Ionic | Extension | Hardness |
| | (° C.) | (wt %) | strength) | of dough | of noodle |
| Comparative | 65 | 0 | 0 | 88.2% | 69.7% |
| Example 4 | | | | | |
| Example 3 | ↑ | 0.3 | 0.05 | 83.6% | 80.8% |
| Example 4 | ↑ | 0.6 | 0.10 | 89.4% | 86.4% |
| Example 5 | ↑ | 0.9 | 0.15 | 95.1% | 89.5% |
| Example 2 | ↑ | 1.2 | 0.21 | 101% | 81.7% |

### Effect of Sterilization

To a solution dissolving the isolated soybean protein A so as to have a concentration of 12% by weight, cultured bacteria group derived from soybean was planted, and heated in a constant temperature water bath at each temperature for 30 minutes. When sodium chloride was added, it was added at a concentration of 1.2% by weight (ionic strength of 0.21) in the solution, and the solution was heated in the same manner. After cooling, measurements were carried out on viable bacteria cultured in a standard agar medium at 35° C. for 48 hours and on coli group cultured in a desoxycholate agar medium at 35° C. for 24 hours.

The viable bacteria were decreased, and the coli group was not detected by heating at 60° C. or higher. Also in Example 6 of which sodium chloride was added, the effect of sterilization was not changed.

TABLE 3
Effect of sterilization

| | | Concentration of | | | |
|---|---|---|---|---|---|
| | Heating | sodium chloride | | | |
| | temperature | | (Ionic | Viable | Coli |
| | (° C.) | (wt %) | strength) | bacteria | group |
| Comparative | Without | 0 | 0 | 8.8 × 10⁶ | 5.3 × 10³ |
| Example 6 | heating | | | | |
| Comparative | 60 | ↑ | ↑ | 1.1 × 10⁶ | <1 × 10¹ |
| Example 7 | | | | | |
| Comparative | 63 | ↑ | ↑ | 2.2 × 10⁶ | <1 × 10¹ |
| Example 8 | | | | | |
| Comparative | 65 | ↑ | ↑ | 7.0 × 10⁵ | <1 × 10¹ |
| Example 9 | | | | | |
| Example 6 | 60 | 1.2 | 0.21 | 1.3 × 10⁶ | <1 × 10¹ |

### Preparation Example of Soybean Protein Composition

### Example 7

To defatted soybean, 10-fold amount of water was added, the mixture was adjusted to pH 6.7 with sodium hydroxide to be mixed and extracted, and a precipitate was removed by centrifugation to obtain an extracted solution. The extracted solution was adjusted to pH 4.5 with hydrochloric acid to precipitate a protein and recovered by centrifugation. The precipitate was washed and recovered by adding water and carrying out centrifugation again. Water was added so as to have solid content of 10% by weight and then the mixture was neutralized with sodium hydroxide to pH 7.1, and homogenized to be solubilized. Sodium chloride in an amount of 0.7% by weight (ionic strength of 0.12) was added to the solubilized solution and the solution was heated at a liquid temperature of 62° C. with a heat exchanger at a heat medium temperature of 68° C. After keeping in a water bath at 61 to 62° C. for 45 minutes, the reaction solution was spray-dried at a hot air temperature of 183° C. and an exhaust air temperature of 68 to 73° C., thereby obtaining a powdery isolated soybean protein B. For comparison, a powdery isolated soybean protein C was obtained by solubilizing the neutralized solution and spray-drying in the same manner without heating. An extension of dough and a hardness of noodle in noodle preparation test of the isolated soybean protein B were measured and expressed by relative values when respective values of the isolated soybean protein C were assumed to be 100%, the extension of a dough was 104% and the hardness of noodle was 83.4%, and denaturation due to heating was slight.

### Effect of Using Potassium Chloride

### Example 8

To a defatted soybean, 7-fold amount of water was added, the mixture was adjusted to pH 7 with sodium hydroxide to be mixed and extracted, and after removing a precipitate by centrifugation, water of 5-fold amount of the defatted soybean was further added to the residue and treated in the same manner to obtain an extracted solution. The extracted solution was adjusted to pH 4.5 with hydrochloric acid to precipitate a protein and recovered by centrifugation. The precipitate was washed and recovered by adding water and carrying out centrifugation again. Water was added and then the mixture was neutralized with sodium hydroxide to pH 7.1, and adjusted to 11% of dry weight. Sodium chloride in an amount of 0.35% (ionic strength of 0.06) and potassium chloride in an amount of 0.35% (ionic strength of 0.05) were added and dissolved, and the resultant solution was heated at 65° C. for 45 minutes, and then the reaction solution was spray-dried at a hot air temperature of 180° C. and an exhaust air temperature of 72° C., thereby obtaining a powdery isolated soybean protein D. For comparison, a powdery isolated soybean protein E was obtained by spray-drying the neutralized solution in the same manner without heating. An extension of dough and a hardness of noodle in noodle preparation test of the isolated soybean protein D were measured and expressed by relative values when respective values of the isolated soybean protein E were assumed to be 100%, the extension of dough was 81.5% and the hardness of noodle was 84.8%, and denaturation due to heating was slight.

### Preparation Example of High Glycinin Soybean Protein Composition

To defatted soybean in weight of 10 kg, 1.5 kg of 70% ethanol was sprayed while mixing, and the mixture was held at 70° C. for 30 minutes. To this defatted soybean treated with ethanol, 8-fold amount of water was added, the mixture was adjusted to pH 7.7 with sodium hydroxide to be mixed and extracted. After removing a precipitate by centrifugation, water of 5-fold amount of the defatted soybean was further added to the residue and treated in the same manner to obtain an extracted solution. To this defatted soybean treated with ethanol, sodium hyposulfite in an amount of 0.15% by weight was added, the mixture was adjusted to pH 5.8 with sulfuric acid, and a precipitate was recovered by centrifugation. The precipitate was washed and recovered by adding water and carrying out centrifugation again. Water was added again and then the mixture was neutralized with sodium hydroxide to pH 7.5, and the reaction solution was spray-dried at a hot air temperature of 185° C. and an exhaust air temperature of 75° C., thereby obtaining a high glycinin soybean protein powder. In a protein composition of the high glycinin soybean protein powder by SDS-PAGE, β-conglycinin content was 5% and glycinin content was 93% per protein.

The high glycinin soybean protein powder was set at a concentration of 12% by weight and total weight of 350 g in existence or nonexistence of 1.2% by weight of sodium chloride (ionic strength of 0.21) and heat-treated in an oil bath at 90° C. for 30 minutes (liquid temperature of 83° C.). After freeze-dry, the resultant was subjected to a pulverization treatment to be a sample.

In Comparative Example 11 without adding sodium chloride (Table 4), both of an extension of dough and a hardness of noodle were lower than 80%, and denaturation was recognized. In Example 9 of which sodium chloride was added, both of an extension of dough and a hardness of noodle were 80% or more, and denaturation was slight. Further in Example 9, as compared with Comparative Example 10 without heating, the number of viable bacteria decreased, and a high sterilization effect was recognized.

TABLE 4
Preparation example of high glycinin native
soybean protein composition

| | | Concentration of | | | | |
|---|---|---|---|---|---|---|
| | Heating | sodium chloride | | Denaturation degree | | |
| | temperature | | (Ionic | Extension | Hardness | viable |
| | (° C.) | (wt %) | strength) | of dough | of noodle | bacteria |
| Comparative | Without | 0 | 0 | 100% | 100% | 1.4 × 10⁴ |
| Example 10 | heating | | | | | |
| Comparative | 83 | ↑ | ↑ | 39.0% | 28.3% | Not measured |
| Example 11 | | | | | | |
| Example 9 | 83 | 1.2 | 0.21 | 81.0% | 80.7% | 2.0 × 10² |

### INDUSTRIAL APPLICABILITY

According to the present invention, a sterilized and native soybean protein composition can be obtained. The protein can be added to noodles and other foods safely without lowering physical properties, and food with a high protein that has never been achieved so far can be produced.

1. A method for sterilization of native soybean protein composition comprising salting and heating an aqueous solution of soybean protein composition.

2. The method for sterilization of native soybean protein composition according to claim 1, wherein ionic strength at the time of salting is 0.04 or more.

3. The method for sterilization of native soybean protein composition according to claim 2, wherein conditions of heat sterilization are such that the composition temperature is 60° C. or higher, but lower than denaturation temperature of the soybean protein.

4. The method for sterilization of native soybean protein composition according to claim 3, wherein the soybean protein composition contains 10% or more of β-conglycinin, and the heat sterilization condition is lower than 65° C.

5. The method for sterilization of native soybean protein composition according to claim 3, wherein the soybean protein composition contains less than 10% of β-conglycinin, and the heat sterilization condition is lower than 85° C.

6. A method for producing soybean protein composition comprising using the method for sterilization according to claim 1.

7. A method for producing sterilized soybean protein composition according to claim 6, wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
cutting the noodle strip into width of 1.2 mm by cutting blade to prepare noodle string;
leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.

8. A soybean protein composition, which is obtained by the production method according to claim 6.

9. A method for producing soybean protein composition comprising using the method for sterilization according to claim 2.

10. A method for producing sterilized soybean protein composition according to claim 9, wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
cutting the noodle strip into width of 1.2 mm by cutting blade to prepare noodle string; leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.

11. A soybean protein composition, which is obtained by the production method according to claim 9.

12. A method for producing soybean protein composition comprising using the method for sterilization according to claim 3.

13. A method for producing sterilized soybean protein composition according to claim 12, wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes; combining and rolling out the dough by a hand crank pasta machine to be noodle strip with thickness of 1.2 mm;
cutting the noodle strip into width of 1.2 mm by cutting blade to prepare noodle string; leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.

14. A soybean protein composition, which is obtained by the production method according to claim 12.

15. A method for producing soybean protein composition comprising using the method for sterilization according to claim 4.

16. A method for producing sterilized soybean protein composition according to claim 15, wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
cutting the noodle strip into width of 1.2 mm by cutting blade to prepare noodle string;
leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.

17. A soybean protein composition, which is obtained by the production method according to claim 15.

18. A method for producing soybean protein composition comprising using the method for sterilization according to claim 5.

19. A method for producing sterilized soybean protein composition according to claim 18, wherein both values of extension of dough and hardness of noodle obtained by using soybean protein after heating are 80% or more than the values obtained by using soybean protein before heating, wherein the extension of dough is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
leaving the noodle strip to stand overnight at 4° C.;
passing the noodle strip through a 1.2 mm-roller again and cutting into 40 mm×40 mm after getting back to normal temperature;
placing the noodle strip on a plate having a hole with diameter of 16 mm, and placing the same plate with a hole (weight of 1002 g) thereon to fix the noodle strip;
penetrating the noodle strip at a rate of 1 mm/sec using a spherical plunger with diameter of 5 mm; and
obtaining extension of dough as displacement of a break point (assuming a point of being in contact with the sample to be 0 point),
and the hardness of noodle is defined as a value obtained by a method comprising the steps of:
mixing 33.5 g of flour, 17.5 g of powdered soybean protein composition, 2.5 g of sodium chloride and water by hand to form into crumbly dough;
adjusting an amount of water so that the dough has appropriate hardness such as cold rice held by hand;
putting together and kneading the dough;
degassing the dough with a vacuum sealer after putting the dough to rest for 5 minutes;
combining and rolling out the dough by a hand crank pasta machine to be noodle strip with thickness of 1.2 mm;
cutting the noodle strip into width of 1.2 mm by cutting blade to prepare noodle string; leaving the noodle string to stand overnight at 4° C.;
boiling the noodle string at 100° C. for 5 minutes;
15 minutes after boiling up, compressing to 0.1 mm from the bottom face of the noodle string at plunger rate of 0.05 mm/sec using a wedge-shaped plunger; and
obtaining hardness of noodle as a load at a break point.

20. A soybean protein composition, which is obtained by the production method according to claim 18.
